(19) United States
(12) Patent Application Publication
(10) Pub. No.: US 2023/0410073 A1
(43) Pub. Date: Dec. 21, 2023

(54) METHODS, SYSTEMS, APPARATUSES, AND DEVICES FOR FACILITATING MANAGING COLLECTIBLES FOR OWNERS OF THE COLLECTIBLES

(71) Applicant: Jason Kelly Peixoto, Sevierville, TN (US)

(72) Inventor: Jason Kelly Peixoto, Sevierville, TN (US)

(21) Appl. No.: 18/336,371

(22) Filed: Jun. 16, 2023

Related U.S. Application Data
(60) Provisional application No. 63/353,672, filed on Jun. 20, 2022.

(51) Int. Cl. G06Q 20/12; A47G 1/12

(52) U.S. Cl. CPC G06Q 20/1235; A47G 1/12; G06Q 2220/10

(57) ABSTRACT

An apparatus for facilitating managing collectibles for owners of the collectibles. The apparatus comprises a case and a communication unit. The case includes a holder for securing a collectible for storing the collectible. The communication unit broadcasts a collectible data programmed into the communication unit. The collectible data comprises an original owner of the collectible comprised in the apparatus. The collectible data is capturable by a first device comprising a first communication unit, a first processing device, and a first output device. The first communication unit communicates with the communication unit for receiving the collectible data. The first processing device accesses a distributed ledger comprising a current entry of a current owner of the collectible and a previous transfer entry of a previous transfer of an ownership of the collectible based on the collectible data. The first output device presents the current entry and the previous transfer entry.

### FIELD OF THE INVENTION

Generally, the present disclosure relates to the field of data processing. More specifically, the present disclosure relates to methods, systems, apparatuses, and devices for facilitating managing collectibles for owners of the collectibles.

### BACKGROUND OF THE INVENTION

Physical collectibles have been around for generations consisting of coins, cards, and comic books, amongst other collectibles. For larger collectibles such as art there is a provenance that distinguishes the art and essentially acts as a paper trail for the artwork, creating a history of transfers recorded throughout time. This provenance allows stolen artwork to be tracked back to the last legitimate owner. Unfortunately, with collectibles not having a proper provenance, the history of owners cannot be tracked, creating difficulties to return collectibles to their rightful owner in the event of a collectible being stolen. Furthermore, much of the provenance for artwork is mainly within a physical form and is not digitized, limiting the effectiveness and convenience of establishing providence documentation.

Existing techniques for managing collectibles for owners of the collectibles are deficient with regard to several aspects. For instance, current technologies do not include a case that can be sealed shut once a collectible is stored in the case. Furthermore, current technologies do not include programming ownership of an original owner of the collectible to the case. Moreover, current technologies do not immutably record transferring of the ownership of the collectible and verify possession of the collectible. Furthermore, current technologies do not include continuous monitoring of the collectible and immutably recording removal of the collectible from an area as stealing of the collectible.

Therefore, there is a need for improved methods, systems, apparatuses, and devices for facilitating managing collectibles for owners of the collectibles that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for facilitating managing collectibles for owners of the collectibles, in accordance with some embodiments. Accordingly, the apparatus may include a case and a communication unit. Further, the case may be configured for storing a collectible. Further, the case may include a holder. Further, the holder may be configured for securing the collectible to the case. Further, the storing of the collectible may be based on the securing. Further, the communication unit may be comprised in the case. Further, the communication unit may be configured for broadcasting a collectible data associated with the collectible comprised in the apparatus. Further, the collectible data may be programmed into the communication unit using at least one external programming device. Further, the collectible data may include an original owner of the collectible comprised in the apparatus. Further, the collectible data may be capturable by at least one first device. Further, the at least one first device may include a first communication unit, a first processing device, and a first output device. Further, the first communication unit may be configured for communicating with the communication unit of the apparatus for receiving the collectible data. Further, the first processing device may be communicatively coupled with the first communication unit. Further, the first processing device may be configured for accessing a distributed ledger of a blockchain associated with an ownership of the apparatus based on the collectible data. Further, the distributed ledger may include a current entry of a current owner of the collectible comprised in the apparatus and at least one previous transfer entry of at least one previous transfer of the ownership of the collectible from the original owner to the current owner. Further, the first output device may be communicatively coupled with the first processing device. Further, the first output device may be configured for presenting the current entry of the current owner and the at least one previous transfer entry establishing the transfer of the collectible from the original owner to the current owner.

Further disclosed herein is an apparatus for facilitating managing collectibles for owners of the collectibles, in accordance with some embodiments. Accordingly, the apparatus may include a case and a communication unit. Further, the case may be configured for storing a collectible. Further, the case may include a holder. Further, the holder may be configured for securing the collectible to the case. Further, the storing of the collectible may be based on the securing. Further, the storing of the collectible may include unremovably storing of the collectible. Further, the unremovably storing of the collectible may be based on the securing. Further, the case may be configured to be unopeably closed after the storing of the collectible. Further, the unremovably storing of the collectible may be based on the unopenably closing of the case. Further, the communication unit may be comprised in the case. Further, the communication unit may be configured for broadcasting a collectible data associated with the collectible comprised in the apparatus. Further, the collectible data may be programmed into the communication unit using at least one external programming device. Further, the collectible data may include an original owner of the collectible comprised in the apparatus. Further, the collectible data may be capturable by at least one first device. Further, the at least one first device may include a first communication unit, a first processing device, and a first output device. Further, the first communication unit may be configured for communicating with the communication unit of the apparatus for receiving the collectible data. Further, the first processing device may be communicatively coupled with the first communication unit. Further, the first processing device may be configured for accessing a distributed ledger of a blockchain associated with an ownership of the apparatus based on the collectible data. Further, the distributed ledger may include a current entry of a current owner of the collectible comprised in the apparatus and at least one previous transfer entry of at least one previous transfer of the ownership of the collectible from the original owner to the current owner. Further, the first output device may be communicatively coupled with the first processing device. Further, the first output device may be configured for presenting the current entry of the current owner and the at least one previous transfer entry establishing the transfer of the collectible from the original owner to the current owner.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a perspective view of an apparatus 100 for facilitating managing collectibles for owners of the collectibles, in accordance with some embodiments.

FIG. 2 is a front view of the apparatus 100 with the at least one first device 202, in accordance with some embodiments.

FIG. 3 is a front view of the apparatus 100 with the at least one first device 202, in accordance with some embodiments.

FIG. 4 is a front view of the apparatus 100 with the at least one second device 402, in accordance with some embodiments.

FIG. 5 is a front view of the apparatus 100 with the at least one second device 402, in accordance with some embodiments.

FIG. 6 is a front view of the apparatus 100 with the at least one third device 602, in accordance with some embodiments.

FIG. 7 is a front view of the apparatus 100, in accordance with some embodiments.

FIG. 8 is a schematic diagram of a system 800 for facilitating managing collectibles for owners of the collectibles, in accordance with some embodiments.

FIG. 9 is a block diagram of an apparatus 900 for facilitating managing collectibles for owners of the collectibles, in accordance with some embodiments.

FIG. 10 is a front view of an apparatus 1000 for facilitating managing collectibles for owners of the collectibles, in accordance with some embodiments.

FIG. 11 is a front view of the circuit board 1008 with the BLE unit 1010 and without the battery 1012, in accordance with some embodiments.

FIG. 12 is a front view of the circuit board 1008 with the battery 1012 and without the BLE unit 1010, in accordance with some embodiments.

FIG. 13 is a front view of a collectible 1302 comprised in a case 1304, in accordance with some embodiments.

FIG. 14 is a perspective view of an apparatus 1400 for facilitating managing collectibles for owners of the collectibles, in accordance with some embodiments.

FIG. 15 is an illustration of an online platform consistent with various embodiments of the present disclosure.

FIG. 16 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating managing collectibles for owners of the collectibles, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, apparatuses, and devices for facilitating managing collectibles for owners of the collectibles.

Further, the present disclosure describes a usage of a BLE device with blockchain and security, to track history ownership which is called “provenance”. The first use is for coins (such as collectibles) that are graded and inserted into the holder of this device. Then the original owner is programmed into the Bluetooth Low Energy (BLE) unit of this device. The programming of the original owner proves the ownership and if the coin is sold or traded the owner would transfer ownership to a new user using a mobile app or hardware key like blockchain. Records are then created on a blockchain record proving ownership.

Further, the present disclosure describes creating a digital provenance for collectibles, coins, cards, comic books, and even supply chains. Further, the user may start with the ownership with a ble unit and use blockchain. If the user has a scanner the user can keep inventory of all their items. If an item is stolen the user can report it, so if someone tries to fence the item, the user can prove ownership because the user did not transfer it to the new owner, also store owners will have a scanner and it will tell them this item is stolen and been reported.

Further, the present disclosure describes the device comprising a BLE unit, a mobile application executed on a user device to manage to transfer of items (such as collectibles), a standalone scanner for continuously scanning all items of the user, a blockchain network implemented using a blockchain device for creates a decentralized history of all transfers of the items, and crypto coins for transferring the item based on a payment in the crypto coins for the transfer of the items.

Further, the present disclosure describes a Bluetooth Low Energy (BLE) device with blockchain technology, to create a secure ability to track ownership history, known as provenance. Further, the BLE device helps with tracking the history of the ownership of collectibles.

Further, the present disclosure describes a device that proves ownership of a collectible and allows the ownership of the collectible to be transferred to a new user using a mobile application or a hardware key when selling or trading the collectible. Further, the device includes a case, a mobile application, and a scanner. Further, the mobile application allows for the easy transfer of the collectible between individuals while creating an electronic owner history. Thus, the present disclosure describes creating a digital provenance for collectibles that utilizes a BLE unit and blockchain technology that allows each collectible to be tracked throughout trades. Further, the device utilizes the blockchain and scanners to track and keep an inventory of collectibles within a person's ownership. In order to accomplish this the present disclosure describes a case that is used to store the collectible and house the BLE device. Further, the mobile application allows users to transfer ownership of a collectible easily while creating a secure history of ownership. Additionally, the scanner tracks all the collectibles within a person's possession and indicates any flagged collectibles. Thus, the present invention is a digital provenance for collectibles that utilizes a BLE unit and blockchain technology that allows each collectible to be tracked throughout trades.

Further, the present disclosure describes a Bluetooth Low Energy (BLE) device that creates a digital provenance for collectibles. Further, the BLE device provides users with a system that can track the ownership history of collectibles utilizing blockchain technology. The BLE device intends to provide users with a scanner and mobile application to monitor stolen collectibles, to allow them to be easily returned to their proper owner. Further, the BLE device comprises a case, a mobile application, and a scanner. Further, the components of the BLE device allow the user to track the ownership history of any collectible. Each component communicates wirelessly with each other for creating a fully integrated system to constantly monitor collectibles. Thus, the BLE device provides a digital provenance for collectibles by utilizing a BLE unit and blockchain technology that allows each collectible to be tracked throughout trades.

Further, the present disclosure describes storing a collectible and identifying the collectible with the case. The case is made of mainly a plastic, lightweight, transparent material with a rectangular shape to store collectibles, preferably coins. In a preferred embodiment, the case comprises a BLE unit, a board, and a coin holder. The coin holder is located within the case along the bottom side. The coin holder is made of a plastic material with a rectangular shape and circular cutout to allow for a graded coin to be easily secured within the case. The BLE unit is a local wireless area technology that allows it to send short pieces of data continuously. This allows the BLE unit to broadcast a package that anyone with a scanner can pick up and read. The broadcasted package is sent with the owner's public key to not allow people who don't own the collectible to know its value or specific location. In order to figure out the value or specific location of the collectible, the broadcasted data must be decrypted by the owner's personal device. This along with the broadcasted data changing each time with hopping technology provides a secure way of broadcasting the public key from the BLE unit. Positioned offset the BLE unit and above the coin holder is the board. The board further comprises a battery charger, a battery, a voltage regulator, a memory chip, and a hall effect sensor. The battery is used to provide power to the BLE device and utilizes the voltage regulator to provide a constant output of voltage. The memory chip is utilized for over the air (OTA) upgrades to allow the BLE device to be constantly upgraded with proper security measures to ensure the data is safe. Furthermore, due to the case usually being sealed shut, the hall effect sensor is utilized to allow the authorized user to reset the board with a magnet, to increase convenience. Further, the case can be created in many various shapes and sizes and the BLE unit could utilize various types of wireless communication.

Further, the mobile application executed on a device wirelessly communicates with the case via the BLE unit and board. The mobile application allows owners to initiate transfers of collectibles. Each collectible is assigned a unique identifier which is then tracked using a ledger associated with the mobile application, to ensure keys are properly transferred from one user to the other during a trading interaction. Within the mobile application, in addition to transferring collectibles from one user to another, each user can manage all of their collectibles and view each one's transfer history. The digital provenance for the collectibles, coins, cards, comic books, etc., will be stored within the mobile application, easily accessible by the owner. In a preferred embodiment, the mobile application utilizes the blockchain network. The blockchain network will treat each collectible as a crypto coin that can be transferred from one user to another over the blockchain with two keys. The blockchain network will be capable of running continuous checks throughout the network to ensure that each transaction contains the proper transfer of user keys. If the blockchain network detects an improper transfer it will be flagged as stolen, allowing it to not be transferred within the blockchain network until it is returned to the previous owner and the matter is resolved. The preferred blockchain network is the Ethereum network.

The scanner wirelessly communicated with both the case and the mobile application. In a preferred embodiment, the scanner is designed as a device that constantly monitors the state of all the collectibles within the vicinity as well as their relation to the blockchain network within the mobile application. The scanner allows an individual to check and identify all their collectibles. Once a collectible is removed from the range of a scanner and the scanner cannot communicate with the board, the collectible will be marked as stolen until resolved by the owner. Further, store owners will utilize scanners to identify collectibles and show them if the collectible is stolen and has been reported. This design allows for stolen collectibles to not be easily sold to a third party, increasing the chances that the collectible will be found and returned to the correct owner. The scanner can further be used to check the history of any collectible, validate the collectible, and check for previous owners. With all the components working in tandem with each other, it can be seen that the present disclosure describes providing a digital provenance for collectibles that utilizes a BLE unit and blockchain technology that allows each collectible to be tracked throughout trades.

Further, the present disclosure relates generally to a Bluetooth low energy tracking system. More specifically, the present disclosure describes a device that utilizes the blockchain to establish provenance for physical collectibles.

Further, the present disclosure describes a blockchain provenance tracker.

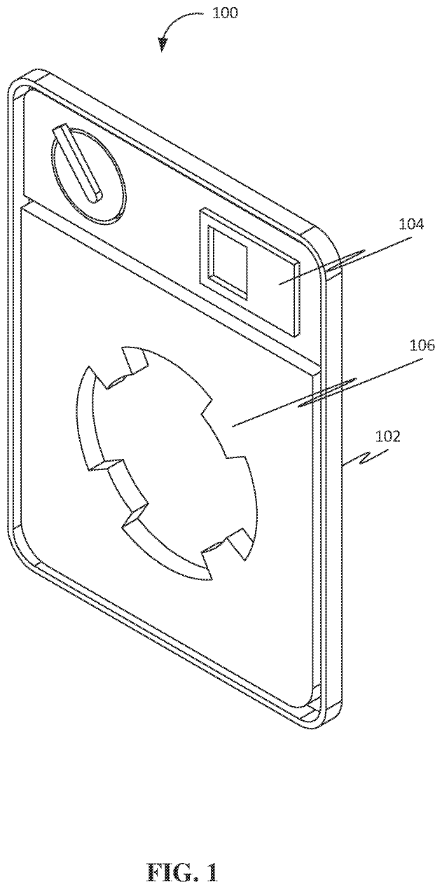

FIG. 1 is a perspective view of an apparatus 100 for facilitating managing collectibles for owners of the collectibles, in accordance with some embodiments. Accordingly, the apparatus 100 may include a case 102 and a communication unit 104. Further, the apparatus 100 may be a BLE device.

Further, the case 102 may be configured for storing a collectible. Further, the case 102 may include a holder 106 (such as the coin holder). Further, the holder 106 may be configured for securing the collectible to the case 102. Further, the holder 106 may be a receptacle comprised in the case 102 for receiving the collectible based on inserting the collectible in the receptacle. Further, the securing may be further based on the receiving of the collectible. Further, the storing of the collectible may be based on the securing. Further, the collectible may include a coin, a card, a book, etc.

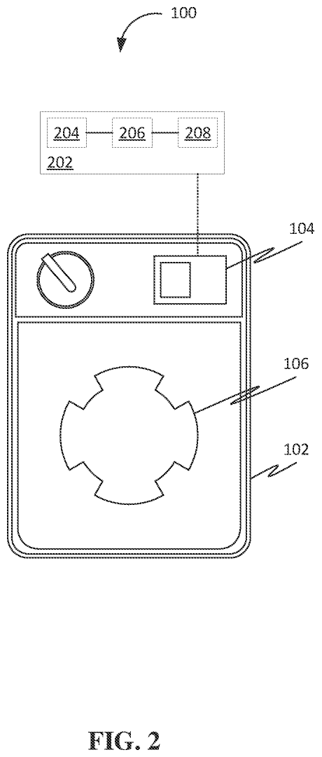

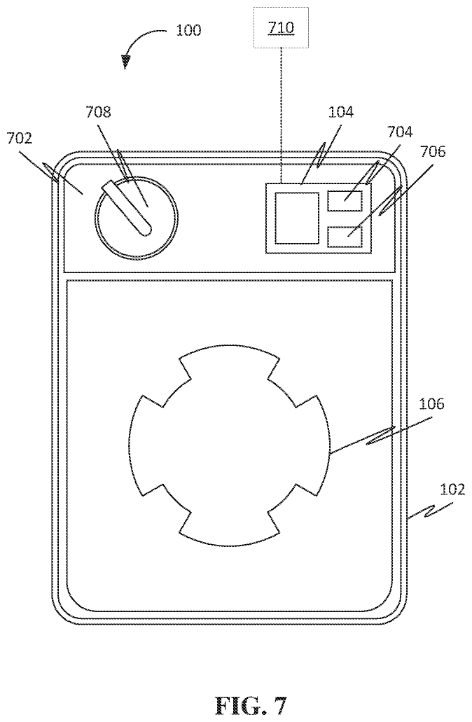

Further, the communication unit 104 may be comprised in the case 102. Further, the communication unit 104 may be a short range communication unit (e.g., a Bluetooth communication unit, a BLE communication unit, an NFC/RFID unit, a WLAN (Wi-Fi) communication unit, a ZigBee communication unit, etc.). Further, the communication unit 104 may include a radio unit for the broadcasting. Further, the communication unit 104 may be configured for broadcasting a collectible data associated with the collectible comprised in the apparatus 100. Further, the collectible data may be broadcasted as a packet by implementing frequency hopping. Further, the packet comprises the public key. Further, the collectible data may be programmed into the communication unit 104 using at least one external programming device 710, as shown in FIG. 7. Further, the at least one external programming device 710 may include a client device, a computing device, etc. Further, the collectible data may include an original owner of the collectible comprised in the apparatus 100. Further, the collectible data may include an identifier uniquely identifying the collectible. Further, the collectible data may be capturable by at least one first device 202, as shown in FIG. 2. Further, the at least one first device 202 may include a computing device, a client device, a user device, a scanner, etc. Further, the at least one first device 202 may include a first communication unit 204, a first processing device 206, and a first output device 208, as shown in FIG. 2. Further, the first communication unit 204 may be configured for communicating with the communication unit 104 of the apparatus 100 for receiving the collectible data. Further, the first processing device 206 may be communicatively coupled with the first communication unit 204. Further, the first processing device 206 may be configured for accessing a distributed ledger of a blockchain associated with an ownership of the apparatus 100 based on the collectible data. Further, the distributed ledger may be implemented on a blockchain network comprising a plurality of blockchain nodes (such as computing devices). Further, the distributed ledger may include a current entry of a current owner of the collectible comprised in the apparatus 100 and at least one previous transfer entry of at least one previous transfer of the ownership of the collectible from the original owner to the current owner. Further, the first output device 208 may be communicatively coupled with the first processing device 206. Further, the first output device 208 may be configured for presenting the current entry of the current owner and the at least one previous transfer entry establishing the transfer of the collectible from the original owner to the current owner. Further, in an embodiment, the communication unit 104 may be electrically coupled with a powering unit for powering the communication unit 104. Further, in an embodiment, the communication unit 104 may be a BLE unit. Further, the first communication unit 204 may include a first radio unit for communicating with the radio unit. Further, the first communication unit 204 may be a short range communication unit (e.g., a Bluetooth communication unit, a BLE communication unit, an NFC/RFID unit, a WLAN (Wi-Fi) communication unit, a ZigBee communication unit, etc.).

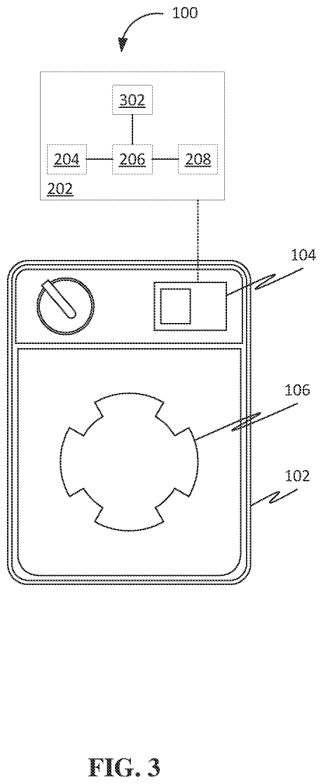

Further, in some embodiments, the at least one first device 202 may include a first input device 302, as shown in FIG. 3, communicatively coupled with the first processing device 206. Further, the first input device 302 may be configured for generating a request for transferring the ownership of the apparatus 100 comprising the collectible from the current owner to a next owner. Further, the first processing device 206 may be configured for creating a next entry of the next owner of the collectible in the distributed ledger and a current transfer entry of a current transfer of the ownership of the collectible from the current owner to the next owner based on the accessing and the request. Further, the creating of the next entry of the next owner of the collectible in the distributed ledger and the current transfer entry of the current transfer of the ownership of the collectible from the current owner to the next owner may include creating a digital provenance for the collectible.

Further, in an embodiment, the collectible data may be encrypted using a public key associated with the collectible and the current owner. Further, the packet comprises the public key. Further, the first processing device 206 may be configured for obtaining a private key associated with the collectible and the current owner. Further, the first processing device 206 may be configured for assigning the private key and the public key to the next owner in the distributed ledger based on the obtaining and the accessing.

Further, in an embodiment, the request may include a suspected current owner of the collectible comprised in the apparatus 100. Further, the first processing device 206 may be configured for comparing the suspected current owner and the current owner comprised in the distributed ledger. Further, the first processing device 206 may be configured for determining a match between the suspected current owner and the current owner based on the comparing. Further, the match may include a positive match and a negative match. Further, the creating of the next entry may be based on the positive match.

Further, in an embodiment, the first processing device 206 may be configured for creating a stolen entry for the collectible comprised in the apparatus 100 based on the negative match and the accessing.

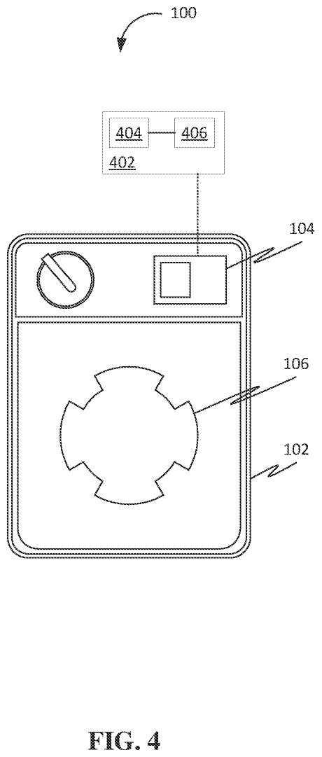

Further, in some embodiments, the collectible data may be capturable by at least one second device 402, as shown in FIG. 4. Further, the at least one second device 402 may include a computing device, a client device, a user device, a scanner, etc. Further, the at least one second device 402 may include a second communication unit 404 and a second processing device 406, as shown in FIG. 4. Further, the second communication unit 404 may be configured for communicating with the communication unit 104 of the apparatus 100 for receiving the collectible data based on a presence of the apparatus 100 within at least one range associated with the second communication unit 404. Further, the second processing device 406 may be communicatively coupled with the second communication unit 404. Further, the second processing device 406 may be configured for determining a removal of the apparatus 100 from the at least one range based on a lapse in the receiving of the collectible data. Further, the second processing device 406 may be configured for accessing the distributed ledger of the blockchain based on the determining of the removal of the apparatus 100 and the collectible data. Further, the second processing device 406 may be configured for creating a stolen entry in the distributed ledger for marking the apparatus 100 as stolen based on the accessing. Further, in an embodiment, the at least one range may be programmable for the second communicating uni 404 using the at least one second device 402.

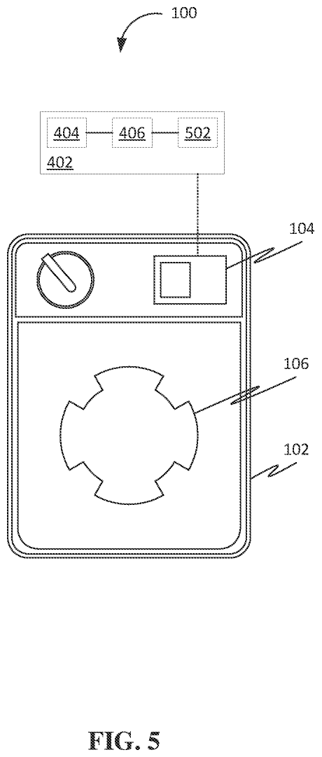

Further, in an embodiment, the at least one second device 402 may include a second input device 502, as shown in FIG. 5, communicatively coupled with the second processing device 406. Further, the second input device 502 may be configured for generating at least one positioning data associated with a positioning of the apparatus 100. Further, the second input device 502 may include an image sensor configured for capturing at least one image of at least one storage area associated with at least one facility for placing the apparatus 100 and an AI processor communicatively coupled with the image sensor for processing the at least one image, determining at least one location in the at least one storage area for the placing of the apparatus 100, and generating the at least one positioning data based on the determining of the at least one location. Further, the second processing device 406 may be configured for analyzing the at least one positioning data. Further, the second processing device 406 may be configured for determining the at least one range for the second communication unit 404 based on the analyzing. Further, the receiving of the collectible data based on the presence of the apparatus 100 within the at least one range may be based on the determining. Further, in an embodiment, the at least one range may be user defined based on receiving the at least one range from the second input device 502.

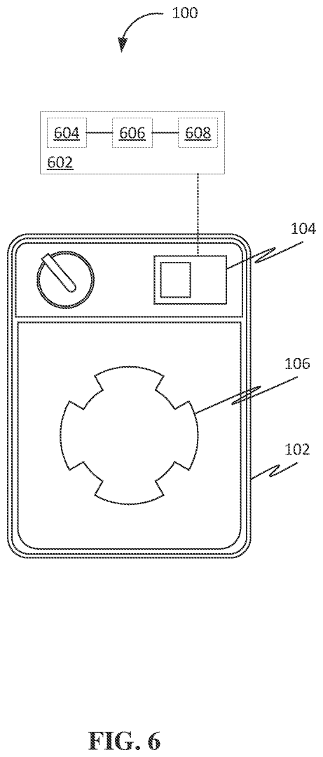

Further, in some embodiments, the collectible data may be encrypted using a public key associated with the collectible and the current owner. Further, the collectible data may be further capturable by at least one third device 602, as shown in FIG. 6. Further, the at least one third device 602 may include a third communication unit 604, a third processing device 606, and a third output device 608, as shown in FIG. 6. Further, the at least one third device 602 may include a computing device, a client device, a user device, a scanner, etc. Further, the third communication unit 604 may be configured for communicating with the communication unit 104 of the apparatus 100 for receiving the collectible data. Further, the third processing device 606 may be communicatively coupled with the third communication unit 604. Further, the third processing device 606 may be configured for obtaining at least one information for locating the collectible comprised in the apparatus 100 by decrypting the collectible data using a private key associated with the collectible and the current owner. Further, the third processing device 604 may include the private key. Further, the third output device 608 may be communicatively coupled with the third processing device 606. Further, the third output device 608 may be configured for presenting the at least one information.

Further, in some embodiments, the communication unit 104 may include a memory chip 704, as shown in FIG. 7. Further, the memory chip 704 stores the collectible data based on the programming of the collectible data into the communication unit 104 using the at least one external programming device 710. Further, the memory chip 704 may include a Bluetooth Low Energy (BLE) chip. Further, the memory chip 704 may include a microcontroller unit (comprising a memory) and a radio unit communicatively coupled with the microcontroller unit. Further, the radio unit allows over-the-air (OTA) communications with the microcontroller unit. Further, the programming may be based on the OTA communications.

Further, in an embodiment, the communication unit 104 may include a hall sensor 706 (hall effect sensor), as shown in FIG. 7, coupled with the memory chip 704. Further, the hall sensor 706 may be configured for erasing the collectible data from the memory chip based on an application of a magnetic field to the hall sensor. Further, the erasing of the collectible data reset the communication unit 104. Further, the communication unit 104 may be configured to be reprogrammed with a new collectible data associated with a new collectible comprised in the apparatus 100 based on the erasing.

Further, in some embodiments, the storing of the collectible may include unremovably storing of the collectible. Further, the unremovably storing of the collectible may be based on the securing.

Further, in an embodiment, the case 102 may be further configured to be unopeably closed after the storing of the collectible. Further, the case 102 may be configured to be sealed shut after the storing of the collectible. Further, the unremovably storing of the collectible may be further based on the unopenably closing of the case 102.

FIG. 2 is a front view of the apparatus 100 with the at least one first device 202, in accordance with some embodiments.

FIG. 3 is a front view of the apparatus 100 with the at least one first device 202, in accordance with some embodiments.

FIG. 4 is a front view of the apparatus 100 with the at least one second device 402, in accordance with some embodiments.

FIG. 5 is a front view of the apparatus 100 with the at least one second device 402, in accordance with some embodiments.

FIG. 6 is a front view of the apparatus 100 with the at least one third device 602, in accordance with some embodiments.

FIG. 7 is a front view of the apparatus 100, in accordance with some embodiments. Further, the apparatus 100 may include a circuit board 702 comprised in the case 102. Further, the communication unit 104 may be comprised in the circuit board 702. Further, the circuit board 702 may include a battery 708 comprised in the circuit board 702. Further, the circuit board 702 may be a printed circuit board (PCB).

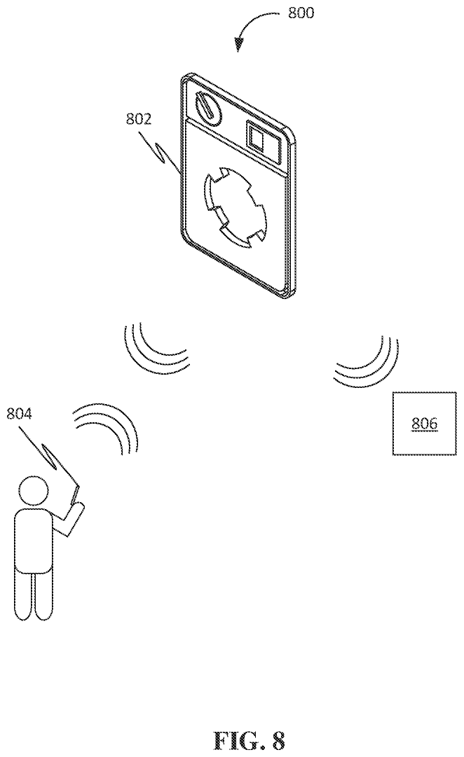

FIG. 8 is a schematic diagram of a system 800 for facilitating managing collectibles for owners of the collectibles, in accordance with some embodiments. Further, the system 800 may include an apparatus 802, a scanner 806, and a user device 804. Further, the user device 804 may execute a software application (such as the mobile application). Further, the apparatus 800 (such as the apparatus 100) may wirelessly communicate with the scanner 806 and the user device 804. Further, the scanner 806 wirelessly communicates with the user device 804.

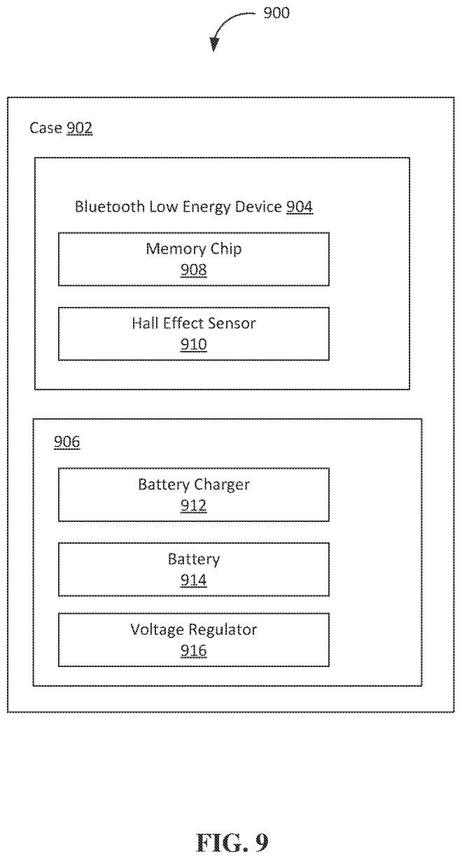

FIG. 9 is a block diagram of an apparatus 900 for facilitating managing collectibles for owners of the collectibles, in accordance with some embodiments. Further, the apparatus 900 may include a Bluetooth Low Energy (BLE) device 904 and a powering unit 906. Further, the BLE device 904 may include a memory chip 908 and a hall effect sensor 910. Further, the powering unit 906 may be configured for powering the BLE device 904. Further, the powering unit 906 may include a battery charger 912, a battery 914, and a voltage regulator 916.

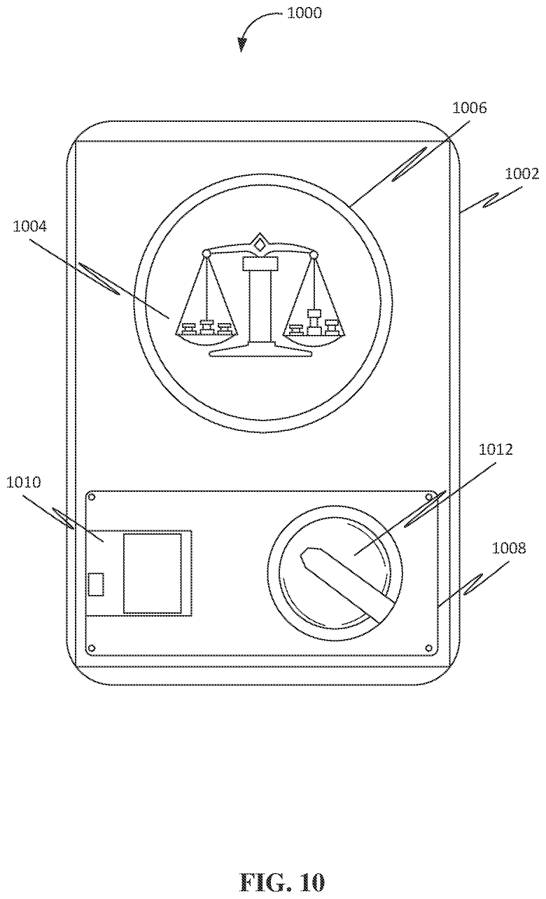

FIG. 10 is a front view of an apparatus 1000 for facilitating managing collectibles for owners of the collectibles, in accordance with some embodiments. Accordingly, the apparatus 1000 may include a case 1002 and a collectible 1004. Further, the case 1002 may include a holder 1006 for securing the collectible 1004 to the case 1002. Further, the case 1002 may include a circuit board 1008 comprising a Bluetooth Low Energy (BLE) unit 1010 and a battery 1012.

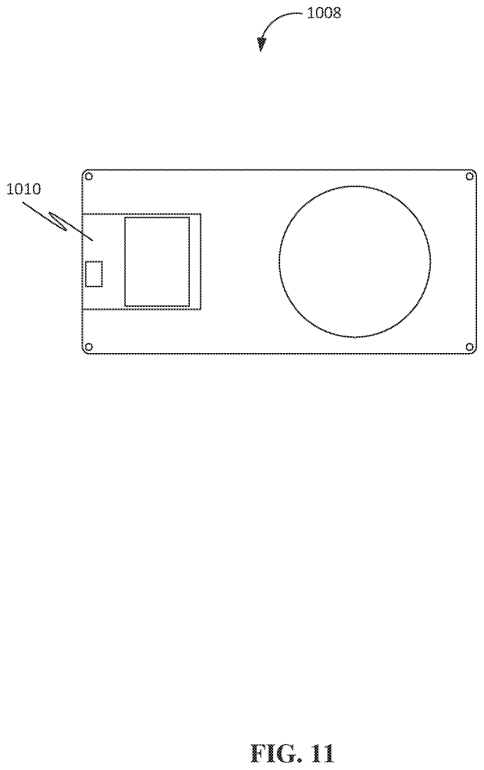

FIG. 11 is a front view of the circuit board 1008 with the BLE unit 1010 and without the battery 1012, in accordance with some embodiments.

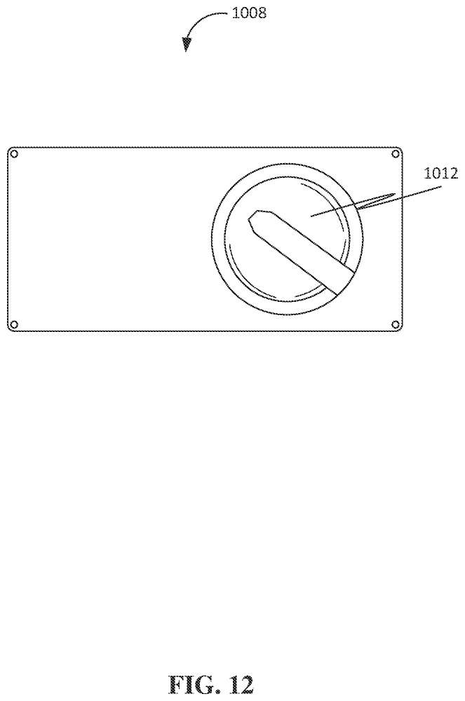

FIG. 12 is a front view of the circuit board 1008 with the battery 1012 and without the BLE unit 1010, in accordance with some embodiments.

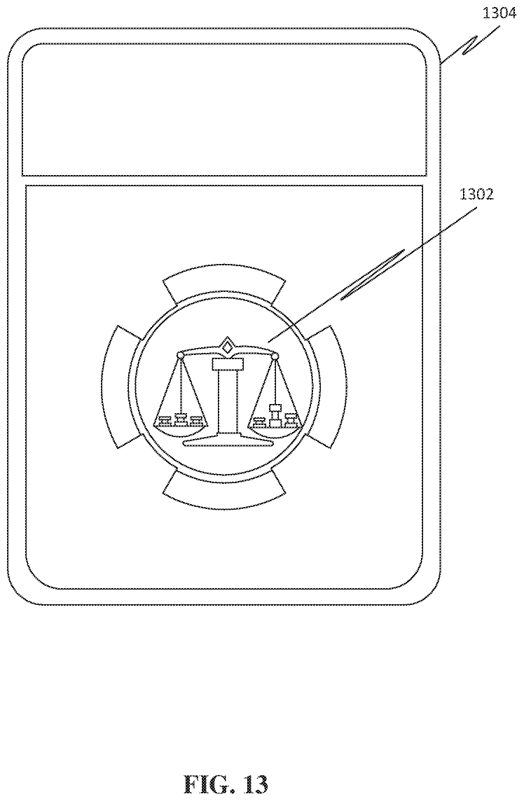

FIG. 13 is a front view of a collectible 1302 comprised in a case 1304, in accordance with some embodiments.

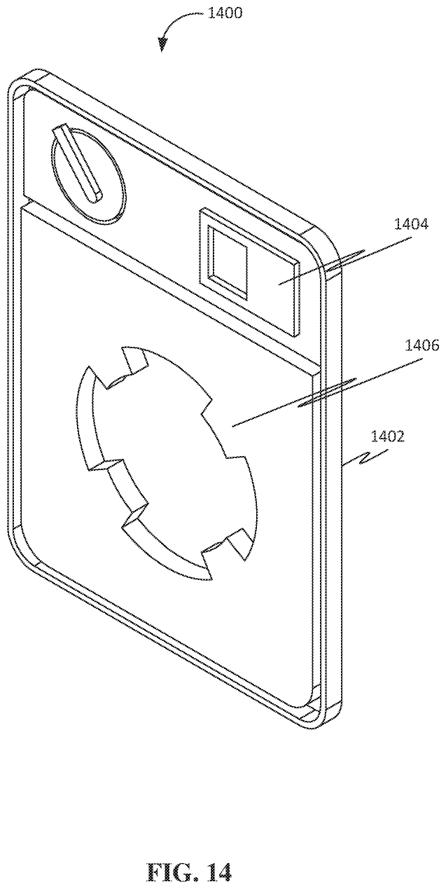

FIG. 14 is a perspective view of an apparatus 1400 for facilitating managing collectibles for owners of the collectibles, in accordance with some embodiments. Accordingly, the apparatus 1400 may include a case 1402 and a communication unit 1404.

Further, the case 1402 may be configured for storing a collectible. Further, the case 1402 may include a holder 1406. Further, the holder 1406 may be configured for securing the collectible to the case 1402. Further, the storing of the collectible may be based on the securing. Further, the storing of the collectible may include unremovably storing of the collectible. Further, the unremovably storing of the collectible may be based on the securing. Further, the case 1402 may be further configured to be unopeably closed after the storing of the collectible. Further, the unremovably storing of the collectible may be further based on the unopenably closing of the case 1402.

Further, the communication unit 1404 may be comprised in the case 1402. Further, the communication unit 1404 may be configured for broadcasting a collectible data associated with the collectible comprised in the apparatus 1400. Further, the collectible data may be programmed into the communication unit 1404 using at least one external programming device. Further, the collectible data may include an original owner of the collectible comprised in the apparatus 1400. Further, the collectible data may be capturable by at least one first device. Further, the at least one first device may include a first communication unit, a first processing device, and a first output device. Further, the first communication unit may be configured for communicating with the communication unit 1404 of the apparatus 1400 for receiving the collectible data. Further, the first processing device may be communicatively coupled with the first communication unit. Further, the first processing device may be configured for accessing a distributed ledger of a blockchain associated with an ownership of the apparatus 1400 based on the collectible data. Further, the distributed ledger may include a current entry of a current owner of the collectible comprised in the apparatus 1400 and at least one previous transfer entry of at least one previous transfer of the ownership of the collectible from the original owner to the current owner. Further, the first output device may be communicatively coupled with the first processing device. Further, the first output device may be configured for presenting the current entry of the current owner and the at least one previous transfer entry establishing the transfer of the collectible from the original owner to the current owner.

Further, in some embodiments, the at least one first device further may include a first input device communicatively coupled with the first processing device. Further, the first input device may be configured for generating a request for transferring the ownership of the apparatus 1400 comprising the collectible from the current owner to a next owner. Further, the first processing device may be further configured for creating a next entry of the next owner of the collectible in the distributed ledger and a current transfer entry of a current transfer of the ownership of the collectible from the current owner to the next owner based on the accessing and the request.

Further, in an embodiment, the collectible data may be encrypted using a public key associated with the collectible and the current owner. Further, the first processing device may be configured for obtaining a private key associated with the collectible and the current owner. Further, the first processing device may be configured for assigning the private key and the public key to the next owner in the distributed ledger based on the obtaining and the accessing.

Further, in an embodiment, the request further may include a suspected current owner of the collectible comprised in the apparatus 1400. Further, the first processing device may be configured for comparing the suspected current owner and the current owner comprised in the distributed ledger. Further, the first processing device may be configured for determining a match between the suspected current owner and the current owner based on the comparing. Further, the match may include a positive match and a negative match. Further, the creating of the next entry may be further based on the positive match.

Further, in an embodiment, the first processing device may be configured for creating a stolen entry for the collectible comprised in the apparatus 1400 based on the negative match and the accessing.

Further, in some embodiments, the collectible data may be capturable by at least one second device. Further, the at least one second device may include a second communication unit and a second processing device. Further, the second communication unit may be configured for communicating with the communication unit 1404 of the apparatus 1400 for receiving the collectible data based on a presence of the apparatus 1400 within at least one range associated with the second communication unit. Further, the second processing device may be communicatively coupled with the second communication unit. Further, the second processing device may be configured for determining a removal of the apparatus 1400 from the at least one range based on a lapse in the receiving of the collectible data. Further, the second processing device may be configured for accessing the distributed ledger of the blockchain based on the determining of the removal of the apparatus 1400 and the collectible data. Further, the second processing device may be configured for creating a stolen entry in the distributed ledger for marking the apparatus 1400 as stolen based on the accessing.

Further, in an embodiment, the at least one second device may include a second input device communicatively coupled with the second processing device. Further, the second input device may be configured for generating at least one positioning data associated with a positioning of the apparatus 1400. Further, the second processing device may be configured for analyzing the at least one positioning data. Further, the second processing device may be configured for determining the at least one range for the second communication unit based on the analyzing. Further, the receiving of the collectible data based on the presence of the apparatus 1400 within the at least one range may be further based on the determining.

Further, in some embodiments, the collectible data may be encrypted using a public key associated with the collectible and the current owner. Further, the collectible data may be further capturable by at least one third device. Further, the at least one third device may include a third communication unit, a third processing device, and a third output device. Further, the third communication unit may be configured for communicating with the communication unit 1404 of the apparatus 1400 for receiving the collectible data. Further, the third processing device may be communicatively coupled with the third communication unit. Further, the third processing device may be configured for obtaining at least one information for locating the collectible comprised in the apparatus 1400 by decrypting the collectible data using a private key associated with the collectible and the current owner. Further, the third output device may be communicatively coupled with the third processing device. Further, the third output device may be configured for presenting the at least one information.

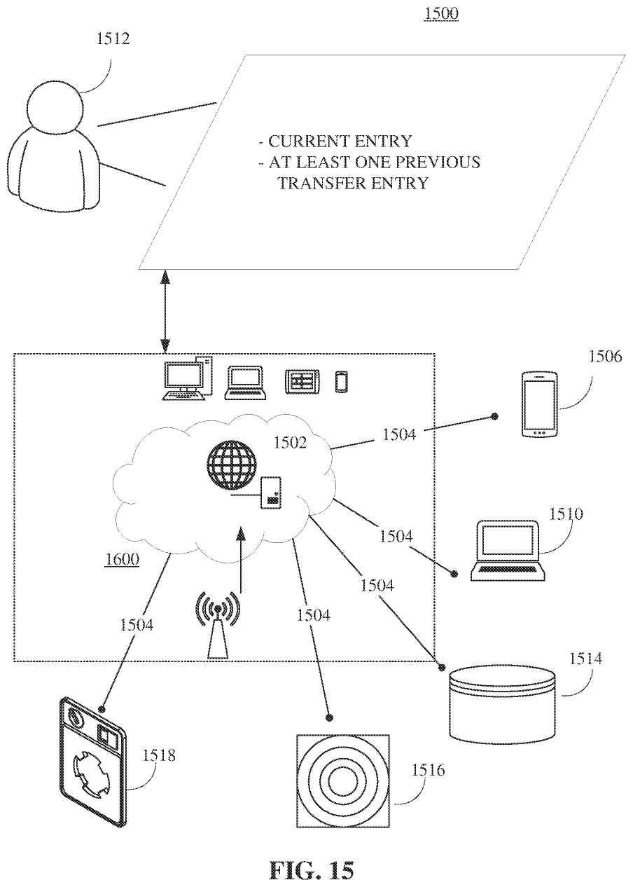

FIG. 15 is an illustration of an online platform 1500 consistent with various embodiments of the present disclosure. By way of non-limiting example, the online platform 1500 to facilitate managing collectibles for owners of the collectibles may be hosted on a centralized server 1502, such as, for example, a cloud computing service. The centralized server 1502 may communicate with other network entities, such as, for example, a mobile device 1506 (such as a smartphone, a laptop, a tablet computer, etc.), other electronic devices 1510 (such as desktop computers, server computers, etc.), databases 1514, sensors 1516, and an apparatus 1518 (such as the apparatus 100, the apparatus 1400, etc.) over a communication network 1504, such as, but not limited to, the Internet. Further, users of the online platform 1500 may include relevant parties such as, but not limited to, end-users, administrators, service providers, service consumers, and so on. Accordingly, in some instances, electronic devices operated by the one or more relevant parties may be in communication with the platform.

A user 1512, such as the one or more relevant parties, may access online platform 1500 through a web based software application or browser. The web based software application may be embodied as, for example, but not be limited to, a website, a web application, a desktop application, and a mobile application compatible with a computing device 1500.

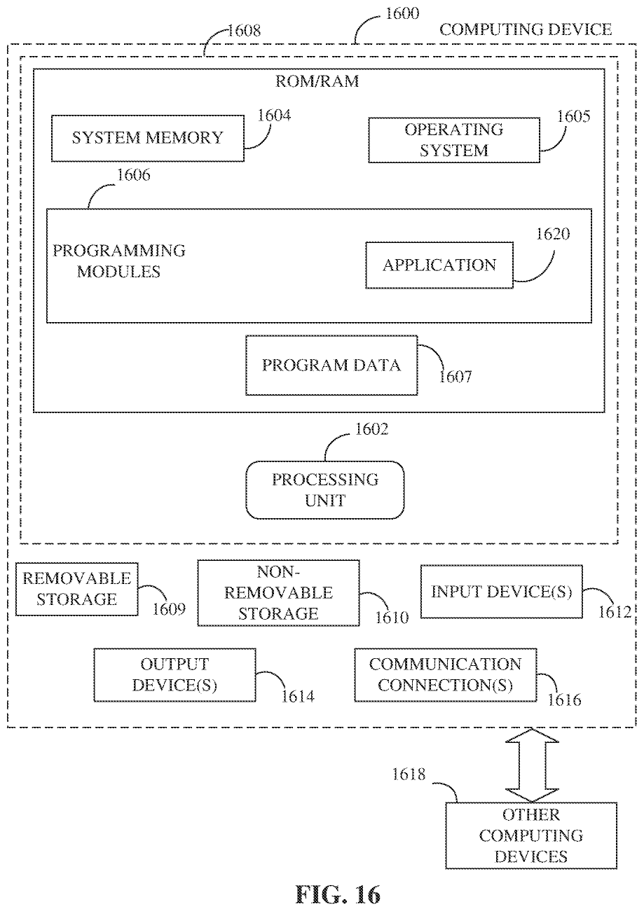

With reference to FIG. 16, a system consistent with an embodiment of the disclosure may include a computing device or cloud service, such as computing device 1600. In a basic configuration, computing device 1600 may include at least one processing unit 1602 and a system memory 1604. Depending on the configuration and type of computing device, system memory 1604 may comprise, but is not limited to, volatile (e.g. random-access memory (RAM)), non-volatile (e.g. read-only memory (ROM)), flash memory, or any combination. System memory 1604 may include operating system 1605, one or more programming modules 1606, and may include a program data 1607. Operating system 1605, for example, may be suitable for controlling computing device 1600's operation. In one embodiment, programming modules 1606 may include image-processing module, machine learning module. Furthermore, embodiments of the disclosure may be practiced in conjunction with a graphics library, other operating systems, or any other application program and is not limited to any particular application or system. This basic configuration is illustrated in FIG. 16 by those components within a dashed line 1608.

Computing device 1600 may have additional features or functionality. For example, computing device 1600 may also include additional data storage devices (removable and/or non-removable) such as, for example, magnetic disks, optical disks, or tape. Such additional storage is illustrated in FIG. 16 by a removable storage 1609 and a non-removable storage 1610. Computer storage media may include volatile and non-volatile, removable and non-removable media implemented in any method or technology for storage of information, such as computer-readable instructions, data structures, program modules, or other data. System memory 1604, removable storage 1609, and non-removable storage 1610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1600. Any such computer storage media may be part of device 1600. Computing device 1600 may also have input device(s) 1612 such as a keyboard, a mouse, a pen, a sound input device, a touch input device, a location sensor, a camera, a biometric sensor, etc. Output device(s) 1614 such as a display, speakers, a printer, etc. may also be included. The aforementioned devices are examples and others may be used.

Computing device 1600 may also contain a communication connection 1616 that may allow device 1600 to communicate with other computing devices 1618, such as over a network in a distributed computing environment, for example, an intranet or the Internet. Communication connection 1616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1604, including operating system 1605. While executing on processing unit 1602, programming modules 1606 (e.g., application 1620 such as a media player) may perform processes including, for example, one or more stages of methods, algorithms, systems, applications, servers, databases as described above. The aforementioned process is an example, and processing unit 1602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. An apparatus for facilitating managing collectibles for owners of the collectibles, the apparatus comprising:
a case configured for storing a collectible, wherein the case comprises a holder, wherein the holder is configured for securing the collectible to the case, wherein the storing of the collectible is based on the securing; and
a communication unit comprised in the case, wherein the communication unit is configured for broadcasting a collectible data associated with the collectible comprised in the apparatus, wherein the collectible data is programmed into the communication unit using at least one external programming device, wherein the collectible data comprises an original owner of the collectible comprised in the apparatus, wherein the collectible data is capturable by at least one first device, wherein the at least one first device comprises:
a first communication unit configured for communicating with the communication unit of the apparatus for receiving the collectible data;
a first processing device communicatively coupled with the first communication unit, wherein the first processing device is configured for accessing a distributed ledger of a blockchain associated with an ownership of the apparatus based on the collectible data, wherein the distributed ledger comprises a current entry of a current owner of the collectible comprised in the apparatus and at least one previous transfer entry of at least one previous transfer of the ownership of the collectible from the original owner to the current owner; and
a first output device communicatively coupled with the first processing device, wherein the first output device is configured for presenting the current entry of the current owner and the at least one previous transfer entry establishing the transfer of the collectible from the original owner to the current owner.

2. The apparatus of claim 1, wherein the at least one first device further comprises a first input device communicatively coupled with the first processing device, wherein the first input device is configured for generating a request for transferring the ownership of the apparatus comprising the collectible from the current owner to a next owner, wherein the first processing device is further configured for creating a next entry of the next owner of the collectible in the distributed ledger and a current transfer entry of a current transfer of the ownership of the collectible from the current owner to the next owner based on the accessing and the request.

3. The apparatus of claim 2, wherein the collectible data is encrypted using a public key associated with the collectible and the current owner, wherein the first processing device is further configured for:
obtaining a private key associated with the collectible and the current owner; and
assigning the private key and the public key to the next owner in the distributed ledger based on the obtaining and the accessing.

4. The apparatus of claim 3, wherein the request further comprises a suspected current owner of the collectible comprised in the apparatus, wherein the first processing device is configured for:
comparing the suspected current owner and the current owner comprised in the distributed ledger; and
determining a match between the suspected current owner and the current owner based on the comparing, wherein the match comprises a positive match and a negative match, wherein the creating of the next entry is further based on the positive match.

5. The apparatus of claim 4, wherein the first processing device is configured for creating a stolen entry for the collectible comprised in the apparatus based on the negative match and the accessing.

6. The apparatus of claim 1, wherein the collectible data is capturable by at least one second device, wherein the at least one second device comprises:
a second communication unit configured for communicating with the communication unit of the apparatus for receiving the collectible data based on a presence of the apparatus within at least one range associated with the second communication unit; and
a second processing device communicatively coupled with the second communication unit, wherein the second processing device is configured for:
determining a removal of the apparatus from the at least one range based on a lapse in the receiving of the collectible data;
accessing the distributed ledger of the blockchain based on the determining of the removal of the apparatus and the collectible data; and
creating a stolen entry in the distributed ledger for marking the apparatus as stolen based on the accessing.

7. The apparatus of claim 6, wherein the at least one second device comprises a second input device communicatively coupled with the second processing device, wherein the second input device is configured for generating at least one positioning data associated with a positioning of the apparatus, wherein the second processing device is configured for:
analyzing the at least one positioning data; and
determining the at least one range for the second communication unit based on the analyzing, wherein the receiving of the collectible data based on the presence of the apparatus within the at least one range is further based on the determining.

8. The apparatus of claim 1, wherein the collectible data is encrypted using a public key associated with the collectible and the current owner, wherein the collectible data is further capturable by at least one third device, wherein the at least one third device comprises:
a third communication unit configured for communicating with the communication unit of the apparatus for receiving the collectible data;
a third processing device communicatively coupled with the third communication unit, wherein the third processing device is configured for obtaining at least one information for locating the collectible comprised in the apparatus by decrypting the collectible data using a private key associated with the collectible and the current owner; and
a third output device communicatively coupled with the third processing device, wherein the third output device is configured for presenting the at least one information.

9. The apparatus of claim 1, wherein the communication unit comprises a memory chip, wherein the memory chip stores the collectible data based on the programming of the collectible data into the communication unit using the at least one external programming device.

10. The apparatus of claim 9, wherein the communication unit comprises a hall sensor coupled with the memory chip, wherein the hall sensor is configured for erasing the collectible data from the memory chip based on an application of a magnetic field to the hall sensor, wherein the erasing of the collectible data reset the communication unit, wherein the communication unit is configured to be reprogrammed with a new collectible data associated with a new collectible comprised in the apparatus based on the erasing.

11. The apparatus of claim 1, wherein the storing of the collectible comprises unremovably storing of the collectible, wherein the unremovably storing of the collectible is based on the securing.

12. The apparatus of claim 11, wherein the case is further configured to be unopeably closed after the storing of the collectible, wherein the unremovably storing of the collectible is further based on the unopenably closing of the case.

13. An apparatus for facilitating managing collectibles for owners of the collectibles, the apparatus comprising:
a case configured for storing a collectible, wherein the case comprises a holder, wherein the holder is configured for securing the collectible to the case, wherein the storing of the collectible is based on the securing, wherein the storing of the collectible comprises unremovably storing of the collectible, wherein the unremovably storing of the collectible is based on the securing, wherein the case is further configured to be unopeably closed after the storing of the collectible, wherein the unremovably storing of the collectible is further based on the unopenably closing of the case; and
a communication unit comprised in the case, wherein the communication unit is configured for broadcasting a collectible data associated with the collectible comprised in the apparatus, wherein the collectible data is programmed into the communication unit using at least one external programming device, wherein the collectible data comprises an original owner of the collectible comprised in the apparatus, wherein the collectible data is capturable by at least one first device, wherein the at least one first device comprises:
a first communication unit configured for communicating with the communication unit of the apparatus for receiving the collectible data;
a first processing device communicatively coupled with the first communication unit, wherein the first processing device is configured for accessing a distributed ledger of a blockchain associated with an ownership of the apparatus based on the collectible data, wherein the distributed ledger comprises a current entry of a current owner of the collectible comprised in the apparatus and at least one previous transfer entry of at least one previous transfer of the ownership of the collectible from the original owner to the current owner; and
a first output device communicatively coupled with the first processing device, wherein the first output device is configured for presenting the current entry of the current owner and the at least one previous transfer entry establishing the transfer of the collectible from the original owner to the current owner.

14. The apparatus of claim 13, wherein the at least one first device further comprises a first input device communicatively coupled with the first processing device, wherein the first input device is configured for generating a request for transferring the ownership of the apparatus comprising the collectible from the current owner to a next owner, wherein the first processing device is further configured for creating a next entry of the next owner of the collectible in the distributed ledger and a current transfer entry of a current transfer of the ownership of the collectible from the current owner to the next owner based on the accessing and the request.

15. The apparatus of claim 14, wherein the collectible data is encrypted using a public key associated with the collectible and the current owner, wherein the first processing device is further configured for:
obtaining a private key associated with the collectible and the current owner; and
assigning the private key and the public key to the next owner in the distributed ledger based on the obtaining and the accessing.

16. The apparatus of claim 15, wherein the request further comprises a suspected current owner of the collectible comprised in the apparatus, wherein the first processing device is configured for:
comparing the suspected current owner and the current owner comprised in the distributed ledger; and
determining a match between the suspected current owner and the current owner based on the comparing, wherein the match comprises a positive match and a negative match, wherein the creating of the next entry is further based on the positive match.

17. The apparatus of claim 16, wherein the first processing device is configured for creating a stolen entry for the collectible comprised in the apparatus based on the negative match and the accessing.

18. The apparatus of claim 13, wherein the collectible data is capturable by at least one second device, wherein the at least one second device comprises:
a second communication unit configured for communicating with the communication unit of the apparatus for receiving the collectible data based on a presence of the apparatus within at least one range associated with the second communication unit; and
a second processing device communicatively coupled with the second communication unit, wherein the second processing device is configured for:
determining a removal of the apparatus from the at least one range based on a lapse in the receiving of the collectible data;
accessing the distributed ledger of the blockchain based on the determining of the removal of the apparatus and the collectible data; and
creating a stolen entry in the distributed ledger for marking the apparatus as stolen based on the accessing.

19. The apparatus of claim 18, wherein the at least one second device comprises a second input device communicatively coupled with the second processing device, wherein the second input device is configured for generating at least one positioning data associated with a positioning of the apparatus, wherein the second processing device is configured for:
analyzing the at least one positioning data using at least one machine learning model; and
determining the at least one range for the second communication unit based on the analyzing, wherein the receiving of the collectible data based on the presence of the apparatus within the at least one range is further based on the determining.

20. The apparatus of claim 13, wherein the collectible data is encrypted using a public key associated with the collectible and the current owner, wherein the collectible data is further capturable by at least one third device, wherein the at least one third device comprises:
a third communication unit configured for communicating with the communication unit of the apparatus for receiving the collectible data;
a third processing device communicatively coupled with the third communication unit, wherein the third processing device is configured for obtaining at least one information for locating the collectible comprised in the apparatus by decrypting the collectible data using a private key associated with the collectible and the current owner; and
a third output device communicatively coupled with the third processing device, wherein the third output device is configured for presenting the at least one information.
